(19) United States
(12) Patent Application Publication
(10) Pub. No.: US 2008/0202990 A1
(43) Pub. Date: Aug. 28, 2008

(54) SIEVE BOX SCREEN ATTACHMENT

(76) Inventor: Deborah Morrow, (US)

Correspondence Address: DEBORAH MORROW, 3721 S. WOODLAND AVE., INDEPENDENCE, MO, 64052, US

(21) Appl. No.: 11/674,641

(22) Filed: Feb. 13, 2007

(51) Int. Cl. B07B 1/46

(52) U.S. Cl. 209/405

(57) ABSTRACT

An attachment device (1) consisting a solid body fastening the sieve frame (2) to the sieve box (3) by attaching first to the sieve box protruding out to slide through an existing hole in the sieve frame or an independent solid (6) entering through the sieve frame then attaching to the sieve box (3). The cylindrical attachment device (6) enters through sieve frame (2) to fasten to the sieve box (3). The attachment device (1) may contain a moveable head (8) once the device is place through at least one hole on the sieve frame (2) fastening to the sieve box (3), the moveable head (8) bends snapping in place to maintain the attachment of the sieve frame (2) to the sieve box (3).

### BACKGROUND OF INVENTION

The present invention is related to sieve frame and box that are used in applications such as in flour mill or other milling operations in the separation or filtration of particles. This invention specifically relates to the attachment of the sieve frame and screening material to the sieve box holding the screened frame in place during the installation process. More specifically, this invention concerns the attachment of the sieve frame with the use of an attachment device either built-up from the sieve box, a connector piece of the sieve frame itself or a separate attachment going through both the sieve frame and sieve box holding both pieces together.

### BRIEF DESCRIPTION OF THE DRAWING FIGURES

A preferred design of the invention is described below in detail and reference to attached drawing at noted:

FIG. 1 Shows a view of the sieve frame attached to the sieve box as shown with the circular objects on opposite sides of the sieve frame. The perimeter of the sieve frame shows the sieve box in which the sieve frame is attached.

FIG. 2 Shows the spirally grooved solid cylinder as placed in the correspondingly grooved hollow cylinder fastening the sieve frame to the sieve box together.

FIG. 3 Shows the protruding nail-shaped or rod-shaped material placed in the correspondingly hole on the sieve frame fastening the sieve frame to the sieve box together.

### SUMMARY OF THE INVENTION

This invention eliminates the shifting of the “glue-on” sieve frame during the installation and provides a placeholder for screening material for a “staple-on” style. This invention specifically addresses the installation in the use of an attachment device, thus eliminating the need for staples and eliminating the tendency of frames to shift during installation.

In the first attachment method, at least one hole is placed in the sieve frame and at least one hole is placed on the surface of the sieve box. The sieve frame is then placed on the sieve box directly aligning matching the holes together. A spirally grooved solid cylinder is placed in the correspondingly grooved hollow cylinder. The recessed head of the spirally grooved cylinder is then rotated to and used to fasten both the sieve frame and the sieve box together.

In the second attachment method, at least one hole is placed in the sieve frame and at least one hole is placed on the surface of the sieve box. A nail-shaped or rod-shaped piece is attached to the sieve box in the hole that was created. The sieve frame is then placed on the sieve box directly aligning the matching hole in the sieve frame to fit correspondingly on the protruding nail-shaped or rod-shaped material. This alignment neatly attaches the sieve frame to the sieve box.

In the third attachment method, at least one hole is placed in the sieve frame and at least one hole is placed on the surface of the sieve box. A nail-shaped or rod-shaped piece is attached to the sieve box in the hole that was created. The sieve frame is then placed on the sieve box directly aligning the matching hole in the sieve frame to fit correspondingly on the protruding nail-shaped or rod-shaped material. This nail-shaped or rod-shaped material would contain a moveable head that would bend or snap to hold the sieve frame in place fastened to the sieve box.

### DESCRIPTION OF RELATED ART

Sieving material is attached to a sieve frame then installed into sieve boxes, sieving material is attached a round sieve holder or the sieving material is attached directly to the sieve box. Sieve boxes or round sieve holders are then stacked one on top of each other within plan sifters or other particle separation equipment. The plan sifter is used to sift, separate or filter particles. The plan sifter is commonly used to sift flour in the process of flour milling or other particle separation process. Sieve boxes are available in either wood or metal material. Screen material can be either synthetic or metal material is secured to a sieve frame, round sieve holder or directly to the sieve box by using either adhesives or staples. When screen material is attached using adhesive, these sieving types are called “glue-on”. When screen material is attached using staples, these sieving types are called “staple-on”. The screening material is replaced during normal scheduled maintenance, when a change is made to required particle size, and/or the screening material wears out.

The installation process for the “glue-on” frame follows the process or re-screening the frame or replacing the used screening material, the frame is then freely placed on the sieve box. This sieve box is then placed within the plan sifter. Another sieve box is placed on top of the first sieve boxes and continues until there are enough sieve boxes placed on top of each other to make the necessary separation of particles. During this stacking process great care has to be taken that the cleaning devices within the sieve box stack do not get lodged between the sieve frame and the sieve box. This commonly occurs as the installation of upper level sieve boxes are installed in the plan sifter.

The installation process for the “staple-on” style, the screening material is attached directly to the sieve box using industrial staples. The screen material can have sewn cloth edges, bonded cloth or no additional edging along the outer perimeter of the screening material. The additional of an outer perimeter material helps in the attachment of industrial staples. The screening material is then attached directly to the sieve by stapling the screening material to the sieve box. The attachment using staples to a sieve box causes wear by creating chips, nicks, cracks, and/or holes over continued use.

U.S. Pat. No. 6,202,857 discloses a sifter frame constructed of both metal and synthetic foamed covering to create a sifter frame. When this frame is installed in the sieve box the cleaning devices can get lodged between the sieve frame and the sieve box. This often occurs during the installation of the upper level sieve boxes in the plan sifter.

Due to the problems references and other disadvantages in the prior art, the need exists to improve the method of attachment and installation of a sieve frame and screening material to a sieve box.

### DETAILED DESCRIPTION OF THE INVENTION

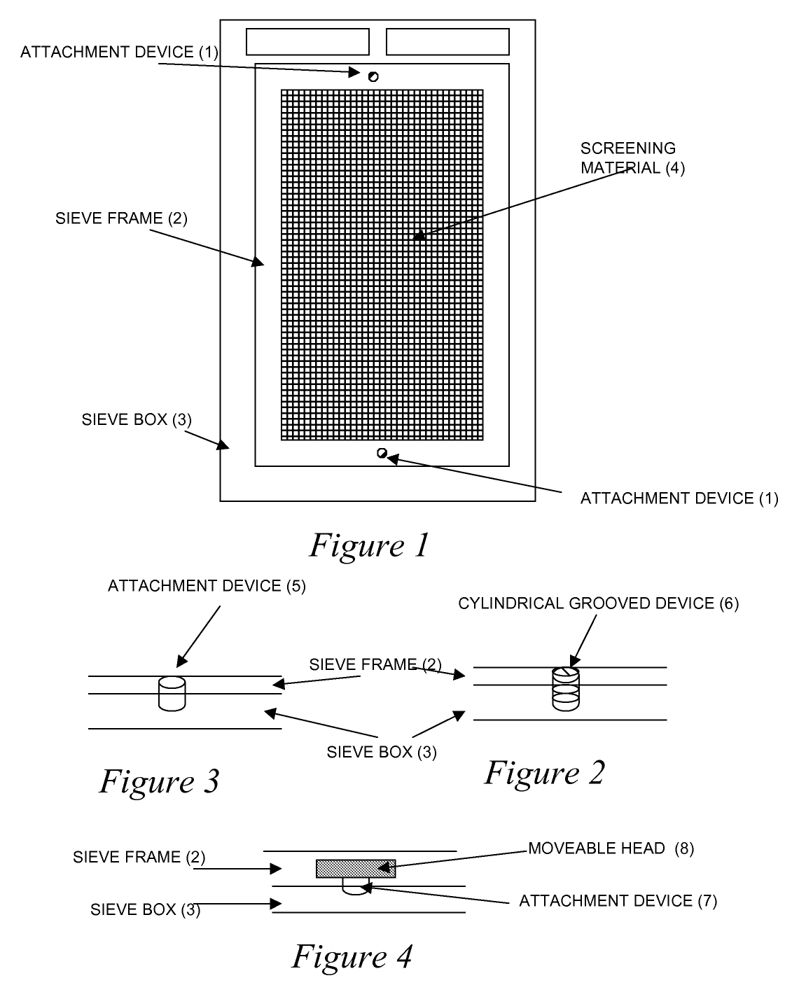

With reference to the figures, the sieve frame can be made from either metal, wood, or a synthetic material this frame is attached to the sieve box by the use of an attachment device either protruding from the sieve box then attaching to the sieve frame or a separate device attaching the sieve frame to the sieve box. This protruding device can be of a cylindrical or squared shape. In FIG. 1, a cylindrical shape is illustrated. This shape can be made from any type of solid material such as a heavy duty synthetic, wood, or metal.

In FIG. 2, the attachment device is shown as a cylindrically grooved shaped spiral attaching the sieve frame to the sieve box. This sieve frame and spiral attachment can be made from any type of solid material such as a heavy-duty synthetic, wood, or metal approved to use in a food process application.

In another attachment method as shown in FIG. 4, the cylindrically grooved shaped spiral contains a moveable head that snaps into place fastening the sieve frame to the sieve box. This moveable head allows for deviation of the grooved hole placement to not specifically align with the hole placement on the sieve frame, thus allowing more flexibility in the potential deviations in sieve box dimensions and/or changes to sieve frames and/or sieve boxes as exposed to variations in temperature and humidity changes. This sieve frame and the cylindrically grooved shaped spiral with a moveable head attachment can be made from any type of solid material such as a heavy-duty synthetic, wood, or metal approved to used in a food process application.

1. Sieve frame attachment device consisting of;
a. A cylindrically grooved shaped spiral used on a prepared sieve frame containing at least one hole to accommodate the spiral device; a sieve box containing at least one hole to accommodate the spiral device. The cylindrically grooved shaped spiral slides through each aligned hole fastening the sieve frame and sieve box.

2. Sieve frame attachment device that embeds in the sieve box protruding through at least one hole to accommodate the embedded attachment device fastening the sieve frame and the sieve box.

3. A cylindrically grooved shaped spiral with a moveable head used on a prepared sieve frame containing at least one hole to accommodate the spiral device; a sieve box containing at least one hole to accommodate the spiral device. The cylindrically grooved shaped spiral slides through each aligned hole fastening the sieve frame to the sieve box and moveable head bends snapping in place to maintain the attachment of the sieve frame to the sieve box.

4. Sieve frame attachment device with a moveable head whose base embeds in the sieve box with the moveable head protruding through at least one hole fastening the sieve frame to the sieve box and the moveable head bends snapping in place to maintain the attachment of the sieve frame to the sieve box.
